(19) United States
(12) Patent Application Publication
(10) Pub. No.: US 2005/0253994 A1
(43) Pub. Date: Nov. 17, 2005

(54) Method for manufacturing electro-optic device and electro-optic device

(76) Inventors: Motohiro Kamijima, Tatsuno (JP); Satoshi Taguchi, Matsumoto (JP); Koji Asada, Hotaka (JP); Shinya Ibuki, Shiojiri (JP); Kunio Maruyama, Misato (JP)

Correspondence Address: HARNESS, DICKEY & PIERCE, P.L.C., P.O. BOX 828, BLOOMFIELD HILLS, MI, 48303, US

(21) Appl. No.: 11/124,588

(22) Filed: May 5, 2005

(30) Foreign Application Priority Data
May 13, 2004 (JP) 2004-143967

(51) Int. Cl. G02F 1/1335; G02F 1/1339

(52) U.S. Cl. 349/155; 349/106

(57) ABSTRACT

A method for manufacturing an electro-optic device having a panel structure including an electro-optic material disposed between a pair of substrates, a spacer disposed between the pair of substrates to define the gap therebetween, and a color filter provided on one of the pair of substrates includes forming a substrate region to be used as the panel structure and a peripheral region to be separated from the substrate region on each of a pair of pre-substrates, bonding the pair of pre-substrates together to form a pre-panel structure, and dividing the pre-panel structure to form the panel structure, wherein a stacked structure including the spacer and a colored layer constituting the color filter or a protective film covering the color filter is disposed in the peripheral region of the pre-panel structure.

### BACKGROUND OF THE INVENTION

1. Technical Field

The present invention relates to a method for manufacturing an electro-optic device and an electro-optic device, and particularly relates to a technique for manufacturing an electro-optic device comprising a color filter and an electro-optic material provided between a pair of substrates, and a spacer for defining the space between the substrates.

2. Related Art

Some electro-optic devices such as liquid crystal displays have a panel structure in which an electro-optic material is disposed between a pair of substrates. In many cases, a spacer is disposed between a pair of substrates, for defining the thickness of the electro-optic material. Known examples of a method for forming the panel structure comprising the spacer include a method in which a spacer comprising independent particles made of a synthetic resin is dispersed on one of a pair of substrates, and then the substrates are bonded together, and a method in which a columnar spacer is formed to project from the inner surface of one of a pair of substrates, and the substrates are bonded together with the columnar space disposed therebetween.

In another method for forming the panel structure using the particulate spacer or the columnar spacer, a pair of pre-substrates larger than a pair of substrates constituting the panel structure is previously bonded together to form a pre-panel structure, and the peripheral portions of the pre-substrates of the pre-panel structure are removed by cutting to form the panel structure. In particular, this method can be applied to manufacture of a relatively small electro-optic device by forming the pre-panel structure including an arrangement of regions for a plurality of electro-optic devices, and then dividing a pair of pre-substrates constituting the pre-panel structure to obtain a plurality of panel structures. Therefore, a plurality of panel structures can be manufactured in parallel, thereby decreasing the manufacturing cost.

On the other hand, in a conventional electro-optic device, strong pressure is easily applied to the peripheries of substrates in a step of bonding the substrates together, and thus, in the periphery of a panel structure, the inter-substrate gap tends to decrease, thereby causing the problem of a display defect. Therefore, Japanese Unexamined Patent Application Publication No. 9-73093 discloses a method for preventing a display defect by increasing the formation density of a columnar spacer outside a display region, i.e., the formation density in the periphery of the display region, or increasing the area of the columnar pacer to suppress a decrease in the inter-substrate gap in the peripheral portion of the panel structure. This document also discloses that in order to further decrease the defect of the inter-substrate gap during bonding of the substrates, the columnar spacer is also formed in a region finally removed by dividing, the region being outside a portion to be used as a panel region in the course of manufacture (refer to lines 12 to 16 in column 4 on page 3 and FIG. 4 of this document). In the document, the columnar spacer is formed by laminating a plurality of colored layers constituting a color filter.

However, in the above-described method including forming the pre-panel structure and then dividing it to form respective panel structures, the particulate or columnar spacer is absent from the peripheral portion around a portion to be used as each panel structure in the pre-panel structure. Therefore, when a pair of pre-substrates is combined and bonded together under pressure, the inter-substrate gap in the peripheral portion becomes smaller than that in the portion to be used as each panel structure. As a reaction, the inter-substrate gap at the edge of the portion to be used as each panel structure varies to cause the problem of increasing variations in the inter-substrate gap in the portion to be used as each panel structure.

For example, in an electro-optic device comprising a pair of substrates bonded together with a sealant disposed therebetween, the particulate or columnar spacer is disposed inside the sealant, and is also mixed in the sealant. However, the spacer is absent from the portion outside the sealant, and thus the inter-substrate gap in the portion outside the sealant decreases to increase the inter-substrate gap in the periphery of the portion inside the sealant with the sealant serving as a fulcrum. Therefore, variations in the inter-substrate gap in the portion inside the sealant increase.

The above-mentioned problem can be resolved to some extent by forming the columnar spacer in the peripheral portion to be finally removed from the panel structure, as disclosed in Japanese Unexamined Patent Application Publication No. 9-73093. However, in the method, the columnar spacer has substantially the same height, but the gap to be defined by the columnar spacer within the display region and the region outside the display region is decreased due to the various thin films formed on the inner surface of a substrate. On the other hand, in the peripheral portion to be finally removed, the gap to be defined by the columnar spacer becomes larger. Therefore, even when a dummy pattern is provided at the same time as the formation of thin film transistor structures, the substantial inter-substrate gap in the peripheral portion becomes smaller than that in the display region and in the region outside the display region. There is thus the problem of failing to sufficiently decrease the variations in the inter-substrate gap in the peripheral portion of each panel structure. In particular, in Japanese Unexamined Patent Application Publication No. 9-73093, the columnar spacer is formed by laminating a plurality of colored layers constituting a color filter. However, the columnar spacer has an area greatly smaller than the pixel area, and thus, in some cases, a stacked structure comprising a plurality of colored layers cannot be wholly formed to a height enough to define the inter-substrate gap, and variations in the height of the spacer also increase. Namely, as the lamination area decreases, the height of a laminate including a plurality of layers becomes smaller than the total thickness of the layers, and variations in the height of the laminate also increase. Therefore, the spacer disclosed in the document has difficult in securing uniformity of the inter-substrate gap.

### SUMMARY

An advantage of the invention is to provide a novel method for manufacturing an electro-optic device capable of decreasing variations in the gap between substrates, as compared with a conventional structure.

According to an aspect of the invention, a method for manufacturing an electro-optic device having a panel structure including an electro-optic material disposed between a pair of substrates, a spacer disposed between the pair of substrates to define the gap therebetween, and a color filter provided on one of the pair of substrates comprises a step of forming a substrate region to be used as the panel structure and a peripheral region to be separated from the substrate region on each of a pair of pre-substrates, a step of bonding the pair of sub-substrates together to form a pre-panel structure, and a step of dividing the pre-panel structure to form the panel structure, wherein a stacked structure including the spacer and a colored layer constituting the color filter or a protective film covering the color filter is disposed in the peripheral region of the pre-panel structure.

According to the aspect of the invention, the stacked structure including the spacer and the colored layer or the protective film is disposed in the peripheral region of the pre-panel structure, and thus the inter-substrate gap in the peripheral region can be securely defined by the stacked structure. In this case, the colored layer constituting the color filter and the protective film covering the color filter have a relatively large thickness, and the spacer is formed apart from the colored film and the protective film. Therefore, the inter-substrate gap in the peripheral region can be prevented from decreasing to be smaller than that in the portion to be used as the panel structure. Since the spacer is formed apart from the color filter, the spacer need not be formed in a stacked structure, and thus the height of the spacer can be precisely determined. Also, the colored layer or the protective layer overlapped with the spacer need not be formed in a restricted narrow region, and thus the precision of the height of the colored layer or the protective layer can be increased. Therefore, in bonding the pair of substrates together, the inter-substrate gap in the peripheral region can be precisely defined, and thus variations in the inter-substrate gap in the electro-optic device can be decreased as compared with a conventional structure.

According to another aspect of the invention, a method for manufacturing an electro-optic device having a panel structure including an electro-optic material disposed between a pair of substrates, a spacer disposed between the pair of substrates to define the gap therebetween, and a color filter provided on one of the pair of substrates comprises a step of forming a substrate region to be used as the panel structure and a peripheral region to be separated from the substrate region on each of a pair of pre-substrates, a step of bonding the pair of sub-substrates together to form a pre-panel structure, and a step of dividing the pre-panel structure to form the panel structure, wherein a stacked structure including the spacer and a colored layer constituting the color filter or a protective film covering the color filter is disposed within the substrate region and the peripheral region of the pre-panel structure.

The stacked structure preferably includes a laminate of a plurality of colored layers. When the stacked structure includes the laminate of a plurality of colored layers, the stacked structure can be formed to a large thickness. Therefore, even when a layered structure overlapped with the spacer in the panel structure is thick, the inter-substrate gap in the peripheral region can be made the same as that in the portion to be used as the panel structure.

The stacked structure preferably includes a laminate of the colored layer and the protective film. When the colored layer and the protective film are laminated, the stacked structure can be formed to a large thickness. Therefore, even when a layered structure overlapped with the spacer in the panel structure has a large thickness, the inter-substrate gap in the peripheral region can be made the same as that in the portion to be used as the panel structure.

An active matrix electro-optic device comprising active elements formed on the inner surface of one of substrates has an over-layer structure in which a thick insulating film is formed between pixel electrodes and wiring electrically connected to the active elements such as TFT (thin film transistor) or TFD (thin film diode), and the active elements are electrically connected to the respective pixel electrodes through contact holes formed in the insulating layer. Therefore, the parasitic capacitance due to the wiring can be decreased to improve the display quality. However, when the over-layer structure is used, the insulating film is laminated on the spacer in the panel structure, and, accordingly, the inter-substrate gap increases. Therefore, the thickness of the stacked structure for defining the inter-substrate gap in the peripheral region must be increased. In this case, however, the thickness of the stacked structure can be increased by laminating the laminate of the plurality of colored layers constituting the color filter and the protective film covering the color filer on the spacer so that the inter-substrate gap in the peripheral region is the same as that in the portion to be used as the panel region.

The panel structure preferably comprises an electrode for applying an electric field to the electro-optic material, a projecting portion provided in one of the pair of substrates to project beyond the other substrate, and wirings and terminals provided on the projecting portion and electrically connected to the electrode. The stacked structure is preferably disposed in a region of the pre-panel structure, in which the wiring and the terminals are not formed, the region corresponding to the projecting portion. The pre-panel structure has a portion in which a region to be used as the projecting portion of one of the substrates faces the peripheral region of the other substrate. However, in the above-described configuration, the stacked structure is disposed in the portion in which the wiring and the terminals are not formed between the region to be used as the projecting portion and the peripheral region of the other substrate. Therefore, when the projecting portion of one of the substrates is exposed by removing the peripheral region of the other substrate from the pre-panel structure, the removal of at least a portion of the stacked structure together with the peripheral region of the other substrate can be prevented, thereby avoiding an adverse effect on the wiring and the terminals.

In the substrate region, preferably, the electrode and the wiring are laminated with an interlayer insulating film provided therebetween, and the stacked structure includes the interlayer insulating film. Since the electrode and the wiring are laminated with the interlayer insulating film provided therebetween, decrease in display quality due to the parasitic capacitance between the electrode and the wiring can be prevented. Also, the interlayer insulating film is included in the stacked structure, and thus an increase in the inter-substrate gap due to the interlayer insulating film can be dealt with without difficulty. For example, even when the interlayer insulating film is thickly formed for sufficiently decreasing the parasitic capacitance, the function of the invention can be securely maintained.

According to a further aspect of the invention, an electro-optic device comprises a pair of substrates bonded together with a sealant; a color filter and an electro-optic material disposed between the pair of substrates; a spacer disposed between the pair of substrates, for defining the gap therebetween; and a stacked structure disposed between the pair of substrates and outside the sealant; the stacked structure comprising the spacer and a colored layer constituting the color filter or a protective film covering the color filter.

In the electro-optic device, the stacked structure comprising the colored layer or the protective film and the spacer is disposed outside the sealant for bonding the pair of substrates together, and thus the inter-substrate gap outside the sealant can be defined, thereby decreasing variations in the inter-substrate gap in the display region formed inside the sealant. Also, not only the spacer but also the colored layer constituting the color filter or the protective film covering the color filter are laminated for defining the inter-substrate gap outside the sealant. Therefore, even when the necessary gap to be defined outside the sealant is larger than the gap to be defined inside the sealant, the inter-substrate gap outside the sealant can be made the same as the inter-substrate gap inside the sealant.

According to a further aspect of the invention, an electro-optic device comprises a pair of substrates bonded together with a sealant; a color filter, an electro-optic material, and an electrode for applying an electric field to the electro-optic material, which are disposed between the pair of substrates; a spacer disposed between the pair of substrates, for defining the gap therebetween; a projecting portion provided on one of the pair of substrates to project beyond the other substrate; and wirings and terminals provided on the projecting portion and electrically connected to the electrode; the spacer being provided on the projecting portion.

Since the spacer is provided on the projecting portion, the inter-substrate gap in a region to be used as the projecting portion can be defined using the spacer before the peripheral region of the other substrate is removed in the manufacturing process. Therefore, variations in the inter-substrate gap in the projecting portion-side periphery of the display region can be decreased. In this case, a stacked structure comprising the spacer and a colored layer constituting the color filter or a protective film covering the color filter may be provided on a region to be used as the protecting portion. Alternatively, the spacer may be provided on the region to be used as the protecting portion, and the colored layer constituting the color filter or the protective film covering the color filter may be provided on the peripheral region of the second substrate. In this case, when the pair of substrates is bonded together, the inter-substrate gap in the region to be used as the projecting portion may be defined by laminating the colored layer or the protective film on the spacer, and then the peripheral region of the other substrate may be removed together with the colored layer or the protective film.

The spacer is preferably a columnar spacer and fixed to at least one of the substrates, but a particulate space may be used. The thickness of the stacked structure is preferably the same as the inter-substrate gap in the panel structure. However, the thickness is not necessarily completely the same as the inter-substrate gap, and the thickness may be slightly smaller than the inter-substrate gap as long as the inter-substrate gap can be maintained.

### BRIEF DESCRIPTION OF THE DRAWINGS

The invention will be described with reference to the accompanying drawings, wherein like numbers reference like elements, and wherein:

FIG. 1 is a schematic plan view schematically showing a pre-panel structure formed in manufacture of an electro-optic device according to an embodiment of the invention;

FIG. 2A is a schematic sectional view showing the pre-panel structure taken along line IIA-IIA in FIG. 1;

FIG. 2B is a schematic sectional view showing the pre-panel structure taken along line IIB-IIB in FIG. 1;

FIG. 3 is an enlarged partial sectional view showing a portion of the pre-panel structure shown in FIG. 1;

FIG. 4 is an enlarged partial sectional view showing another portion of the pre-panel structure shown in FIG. 1;

FIG. 5 is an enlarged partial sectional view showing still another portion of the pre-panel structure shown in FIG. 1;

FIG. 6 is an enlarged partial sectional view showing the display region of an electro-optic device according to an embodiment;

FIG. 7 is a schematic plan view showing the whole configuration of the electro-optic device shown in FIG. 6;

FIG. 8 is a graph showing the cell thickness distribution of the electro-optic device shown in FIG. 6;

FIG. 9 is an enlarged partial plan view showing a portion of the display region of the electro-optic device shown in FIG. 6;

FIG. 10 is an enlarged partial perspective view schematically showing the structure of an active element of the electro-optic device shown in FIG. 6;

FIG. 11 is an enlarged partial sectional view showing a portion of a pre-panel structure according to another embodiment of the invention;

FIG. 12A is an enlarged partial plan view showing a first substrate according to a modified embodiment;

FIG. 12B is an enlarged partial sectional view showing the first substrate shown in FIG. 12A;

FIG. 13 is an enlarged partial sectional view showing a configuration according to the modified embodiment;

FIG. 14 is a flow chart showing steps for manufacturing an electro-optic device according to a further embodiment;

FIG. 15 is a schematic view showing the configuration of a display control system of an electronic apparatus provided with the electro-optic device shown in FIG. 6; and

FIG. 16 is a schematic perspective view showing an example of electronic apparatuses.

### DESCRIPTION OF THE EMBODIMENTS

A method for manufacturing an electro-optic device and an electro-optic device according to an embodiment of the invention will be described in detail below with reference to the attached drawings.

Electro-Optic Device

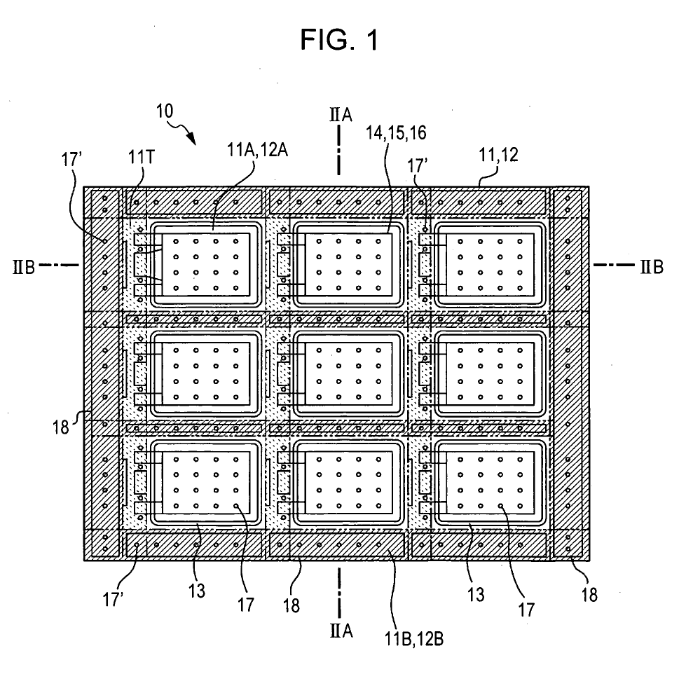

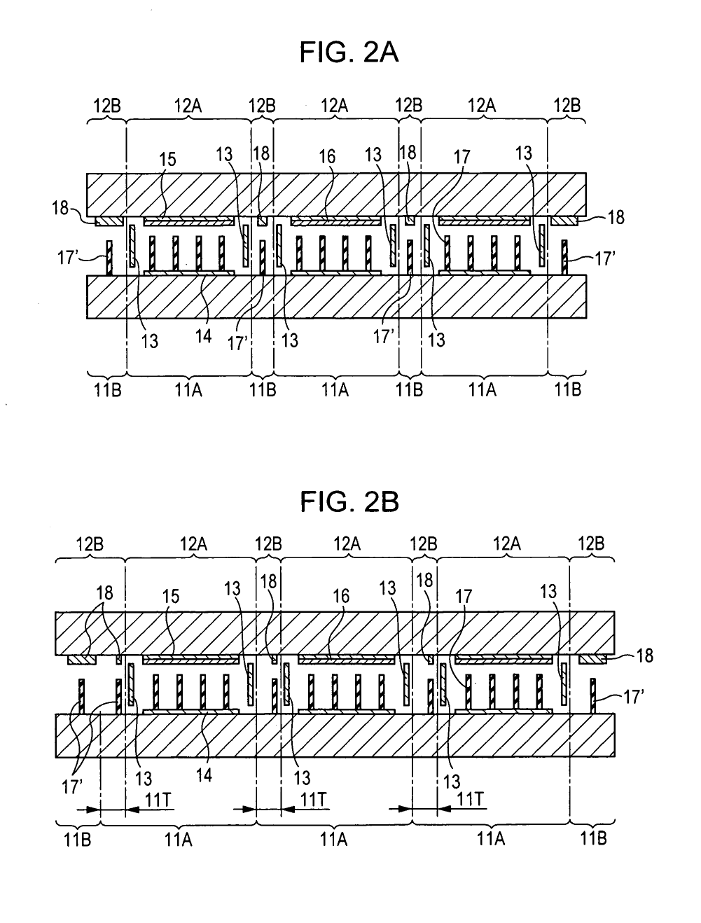

FIG. 1 is a schematic plan view schematically showing a pre-panel structure formed in the manufacturing method according to the embodiment, FIG. 2A is a schematic sectional view schematically showing a sectional structure taken along line IIA-IIA in FIG. 1, and FIG. 2B is a schematic sectional view schematically showing a sectional structure taken along line IIB-IIB in FIG. 1. In each of the attached drawings, the thickness of each layer and thin film, and the dimensions of a spacer are shown as being significantly larger than the thickness of a substrate for convenience of drawing and description, and are different from the actual dimensions. FIGS. 2A and 2B each schematically show the sectional structure of a pre-panel structure 10 before bonding.

In the pre-panel structure 10 according to the embodiment, a first pre-substrate 11 and a second pre-substrate 12 are bonded together with a sealant 13 provided therebetween. Also, a plurality of first substrate regions 11A is arranged in the first pre-substrate 11, and a plurality of second substrate regions 12A is arranged in the second pre-substrate 12, the first substrate regions 11A facing the respective second substrate regions 12A. The first pre-substrate 11 has a first peripheral region 11B, and the second pre-substrate 12 has a second peripheral region 12B, the first peripheral region 11B facing the second peripheral region 12B. Each of the first substrate regions 11A includes a substrate projecting region 11T projecting outward beyond the corresponding second substrate region 12A, the substrate projecting regions 11T facing the second peripheral region 12B.

Each first substrate region 11A, each second substrate region 12A, and the sealant 13 for bonding these regions together constitute a panel structure of an electro-optic device. In this embodiment, a plurality of pre-panel regions to be respectively used as a plurality of panel structures is arranged in the pre-panel structure 10. Each of the pre-panel regions includes a first electrode pattern 14 formed on the inner surface of the first substrate region 11A, and a color filter 15 and a second electrode pattern 16 formed on the inner surface of the second substrate region 12A. Although the actual panel structure will be described in detail below, the details of the panel structure are significantly omitted in FIGS. 1 and 2A and 2B.

The first peripheral region 11B and the second peripheral region 12B are provided in the peripheries of the first pre-substrate 11 and the second pre-substrate 12, respectively. However, in the embodiment shown in the drawings, some of the regions between the plurality of pre-panel regions also have peripheral regions. The first and second peripheral regions 11B and 12B may be provided between the respective pre-panel regions. Alternatively, the first and second peripheral regions 11B and 12B may be provided only in the peripheries of the first pre-substrate 11 and the second pre-substrate 12, respectively, without being provided between the respective pre-panel regions.

Furthermore, a plurality of spacers 17 is disposed inside the sealant 13. The spacers 17 define the inter-substrate gap between each of the first substrate regions 11A and the corresponding second substrate region 12A. The spacers 17 comprise a material different from that of the color filter 15. Furthermore, a plurality of spacers 17′ is disposed between the first peripheral region 11B and the second peripheral region 12B outside the sealant 13, and between the substrate projecting region 11T of each of the first substrate regions 11A and the second peripheral region 12B. The spacers 17 and 17′ are formed on the inner surface of the first pre-substrate 11.

A dummy pattern 18 is formed on the inner surface of the second peripheral region 12B. The dummy pattern 18 comprises the same material as at least one of a plurality of colored layers which constitute the color filter 15, or a protective film (not shown) covering the color filter 15. In the manufacturing process, the dummy pattern 18 is formed at the same time as the color filter 15 or the protective film therefore. The dummy pattern 18 is formed along the periphery of the pre-panel 10 over the entire periphery. Namely, the dummy pattern 18 is formed to surround the area in which the plurality of pre-panel regions is arranged, over the entire periphery of the area. In the embodiment shown in the drawings, the dummy pattern 18 is also formed in some of the regions between the plurality of pre-panel regions. However, the dummy pattern 18 and the spacers 17′ are not necessarily formed between the plurality of pre-panel regions.

In the pre-panel structure 10, the spacers 17′ formed on the inner surface of the first peripheral region 11B are overlapped with the dummy pattern 18 formed on the inner surface of the second peripheral region 12B. Therefore, thee inter-substrate gap between the first peripheral region 11B and the second peripheral region 12B is defined by the stacked structure comprising the spacers 17′ and the dummy pattern 18.

Furthermore, the substrate projecting region 11T is provided on each of the first substrate regions 11A of the first pre-substrate 11 so that the substrate projecting region 11T faces the second peripheral region 12B of the second pre-substrate 12. The substrate projecting region 11T is used as a projecting portion (a substrate projecting portion 110T described below) which is not covered with the other substrate in the panel structure of each of electro-optic devices formed by dividing the pre-panel structure 10. The above-described stacked structure comprising the spacers 17′ and the dummy pattern 18 is also disposed between the substrate projecting regions 11T and the second peripheral region 12B.

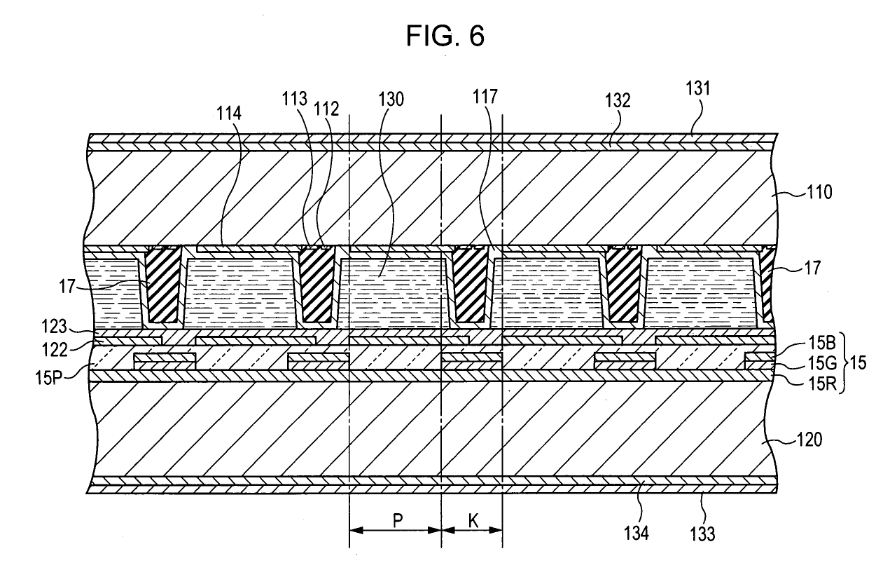

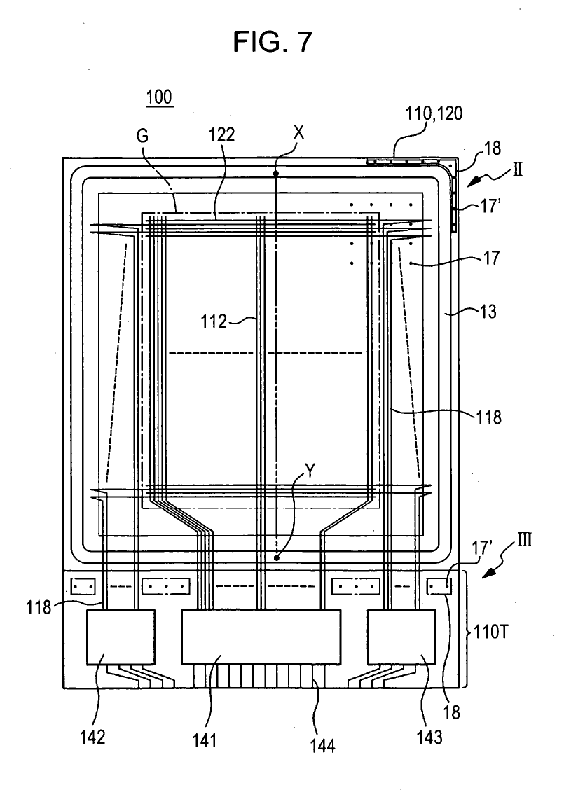

Next, detailed description will be made of the inner structure of an electro-optic device 100 having each of the panel structures formed by dividing the pre-panel structure 10 by the method described below. FIG. 6 is an enlarged partial sectional view schematically showing the internal structure of the display region (inside the sealant) of the electro-optic device 100, and FIG. 7 is a schematic plan view schematically showing the whole structure of the electro-optic device 100.

In the electro-optic device 100, wirings 112 are formed on the inner surface of a first substrate 110 and connected to active elements 113 provided in respective pixel regions P. In the embodiment shown in the drawings, the active elements 113 comprise TFDs (thin film diodes). The active elements 113 are conductively connected to respective pixel electrodes 114 each comprising a transparent conductor such as ITO (indium-tin oxide), zinc oxide, or the like. The pixel electrodes 114 are provided in regions corresponding to the respective pixel regions P.

In this embodiment, the pixel regions P are arranged in a matrix. Also, light shielding regions K are formed between the respective pixel regions P. The pixel electrodes are also arranged in a matrix corresponding to the arrangement form of the pixel regions P to from the electrode pattern 14.

The spacers (columnar spacers) 17 made of an insulating material such as a transparent resin or the like are formed on the inner surface of the first substrate 110. The spacers 17 are provided for defining the inter-substrate gap, and may be appropriately dispersed. Although the spacers 17 are not necessarily formed for each pixel region P, the spacers 17 are provided for each pixel region P in the embodiment shown in the drawings. The spacers 17 are formed in the light shielding regions K. Specifically, the spacers 17 are formed on the wirings 112 and the active elements 113 formed in the respective light-shielding regions K. The spacers 17 are formed by applying a photosensitive material, for example, a photosensitive resin, to a predetermined. thickness on the substrate, and performing exposure and development by photolithography using a predetermined exposure mask. The spacers 17 formed by this method have a single-layer structure, and thus height controllability is high. Therefore, the height precision enough to define the inter-substrate gap can be obtained.

When the spacers 17 having a single-layer structure are formed, it is difficult to form the spacers 17 having varying heights according to places. In the embodiment, the spacers 17′ are formed using the same material as the spacers 17 at the same time as the spacers 17, and the spacers 17′ basically have the same height as that of the spacers 17. Furthermore, an alignment film 117 comprising a polyimide resin or the like is formed on the above-mentioned structure of the first substrate 110.

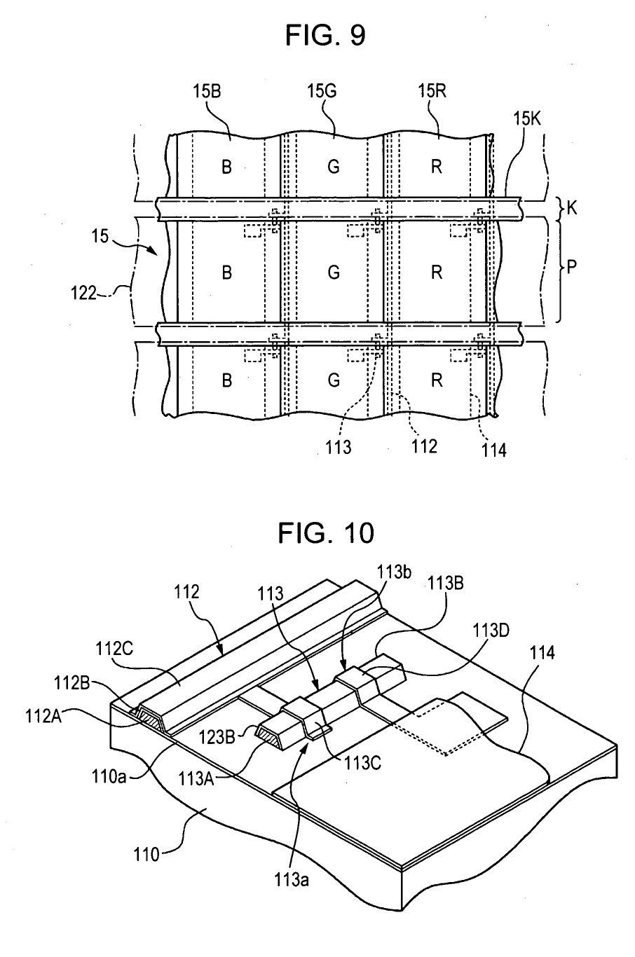

On the other hand, the color filter 15 is formed on the inner surface of a second substrate 120. In the color filter 15, any one of colored layers 15R, 15G, and 15B having plural colors is formed in each of the pixel regions P, the colored layers 15R, 15G, and 15B of plural colors being arranged in a predetermined pattern. For example, in the embodiment shown in FIG. 9, the colored layers 15R, 15G, and 15B are arranged in a so-called stripe pattern. Other examples of the arrangement pattern of the colored layers include various patterns such as a delta pattern, an oblique mosaic pattern, and a Pentile pattern.

A light shielding layer 15K is formed in each of the light shielding regions K. In the embodiment, the light shielding layer 15K comprises at least one of the colored layers 15R, 15G, and 15B. In the embodiment shown in the drawing, the light shielding layer 15K comprises a laminate of all of the three colored layers 15R, 15G, and 15B. Furthermore, a protective film 15P comprising a transparent material such as an acrylic resin or the like is formed over the colored layers 15R, 15G, and 15B, and the light shielding layers 15K. The protective film 15P is provided for planarizing the steps formed by the color filter 15 and the light shielding layers 15K, and suppressing entrance of contaminants in the colored layers 15R, 15G, and 15B from the outside to prevent deterioration of coloring materials.

Counter electrodes 122 comprising a transparent conductor such as ITO or the like are formed on the protective film 15P. In the embodiment, as shown in FIG. 9, a plurality of counter electrodes 122 is arranged in stripes. The pattern of the plurality of counter electrodes 122 constitutes the electrode pattern 16. The counter electrodes 122 extend in the direction perpendicular to the wirings 112 on the first substrate 110. In this embodiment, a diode element (two-terminal nonlinear element) is formed in each of the pixel regions P, and thus a plurality of counter electrodes 122 is provided. For example, when a transistor element (tree-terminal nonlinear element) is formed in each of the pixel regions P, a single counter electrode structure or a counter electrode structure to which a common potential is supplied may be provided.

An alignment film 123 comprising a polyimide resin or the like is formed on the counter electrodes 122. The alignment film 123 is the same as the alignment film 117, and is provided for applying an initial orientation state to a liquid crystal used as the electro-optic material in the embodiment.

In the electro-optic device 100, the first substrate 110 comprises each of the first substrate regions 11A separated by diving the first pre-substrate 11 of the pre-panel structure 10, and the second substrate 120 comprises each of the second substrate regions 12A separated by diving the second pre-substrate 12 of the pre-panel structure 10. A liquid crystal layer 130 used as the electro-optic material is disposed between the first substrate 110 and the second substrate 120. As the liquid crystal layer 130, for example, a TN (twisted nematic) mode or STN (super twisted nematic) mode liquid crystal layer can be used. In the embodiment shown in FIG. 6, a polarization plate 131 and a retardation plate 132 are disposed on the outer surface of the first substrate 110, and a polarization plate 133 and a retardation plate 134 are disposed on the outer surface of the second substrate 120.

As shown in FIG. 7, the wirings 112 on the first substrate 110 extend outward from the display region G to the region outside the sealant 13 and are led to the surface of the substrate projecting portion 110T corresponding to the substrate projecting region 11T. The counter electrodes 122 on the second substrate 12 extend outward from the display region G and are conductively connected to wirings 118 on the first substrate 110 through vertical conductive portions and led to the surface of the substrate projecting portion 110T. In the embodiment shown in the drawings, the sealant 13 is used for the vertical conductive portions for conductively connecting the counter electrodes 122 and the wirings 118. In this case, the sealant 13 contains many conductive fine spacer particles dispersed therein to form an anisotropic conductive material. The sealant 13 used may partially comprise an anisotropic conductive material, or the sealant 13 used may entirely comprise an anisotropic conductive material. Alternatively, the vertical conductive portions may be provided apart from the sealant 13 without using the sealant 13.

In the substrate projecting portion 110T, driving circuits (semiconductor integrated circuits) 141, 142, and 143 are mounted on the surface thereof so as to be conductively connected to the wirings 112 and 118. Also, a plurality of input terminals 144 is arranged at the end of the substrate projecting portion 110T so as to be conductively connected to the driving circuits 141, 142, and 143.

FIG. 10 is a perspective view showing the detailed structure of each active element 113. As shown in FIG. 10, the active element (TFD element) 113 comprises a first TFD element 113a and a second TFD element 113b which are connected in series. For example, the active element 113 is formed as follows: First, an underlying layer 110a made of Ta₂O₅ or the like is formed on the substrate 110, for improving adhesion and preventing contamination. Next, first metal layers 112A of the wirings 112 and first metal layers 113A of the active elements 113 are formed on the underlying layer 110a by sputtering and photolithography using a metal such as Ta (tantalum), TaW, or the like. Next, the surfaces of the first metal layers 112A and 113A are oxidized by anodic oxidation or the like to form insulating films 112b of the wirings 112 and insulating films 113b of the active elements 113 each comprising Ta₂O₅ or the like. Then, Cr (chromium) is deposited on the insulating films 112B and 113B to form second metal layers 112C of the wirings 112 and second metal layers 113C and 113D of the active elements 113.

Each of the wirings 112 comprises the first metal layer 112A, the insulating film 112B, and the second metal layer 112C. The first TFD element 113a comprises the first metal layer 113A, the insulating film 113B, and the second metal layer 113C, and the second TFD element 113b comprises the first metal layer 113A, the insulating film 113B, and the second metal layer 113D. The second metal layer 113C of the first TFD element 113a extends to the second metal layer 112C of each wiring 112. The second metal layer 113D of the second TFD element 113b is formed so that the end thereof overlaps the corresponding pixel electrode 114 and is conductively connected thereto.

In the first TFD element 113b, the current flowing from the wiring 112 to the pixel electrode 144 through the active element 113 flows through the second metal layer 113C, the insulating film 113B, and the first metal layer 113A in that order. In the second TFD element 113b, the current flows through the first metal layer 113A, the insulating film 113B, and the second metal layer 113D in that order. Namely, in each of the active elements 113, a pair of electrically opposed TFD elements is connected in series. This structure is generally referred to as a “back-to-back structure”, and the TFD element having the structure is known to have stable characteristics as compared with a single TFD element.

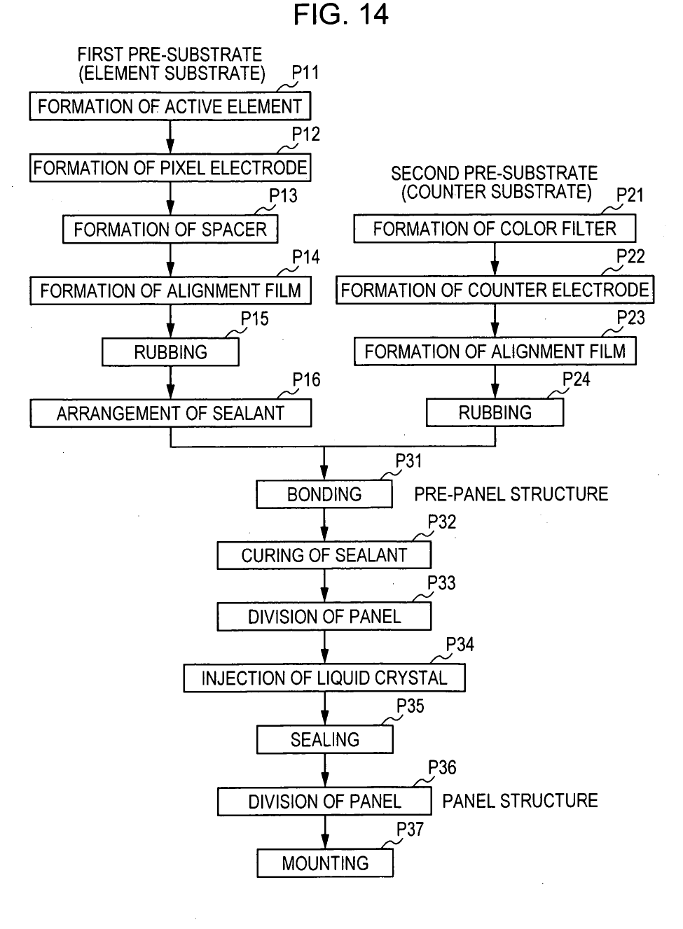

Next, the outline of the method for manufacturing the electro-optic device according to the embodiment will be described with reference to FIG. 14. FIG. 14 is a drawing showing the manufacturing steps according to an embodiment. In order to manufacture the electro-optic device 100, a first pre-substrate forming process ranging from step P11 of forming active elements to step P16 of arranging a sealant and a second pre-substrate forming process ranging from step P21 of forming a color filter to subbing step P24 are separately performed. In this embodiment, each of the pre-substrate forming processes is performed using the pre-substrate including the pre-panel regions corresponding to a plurality of electro-optic devices. Then, a pair of the pre-substrates is bonded together to form the pre-panel structure, and the pre-panel structure is appropriately divided into a plurality of electro-optic devices each having the panel structure. However, a pair of substrates each having a single pre-panel region may be bonded together, and then the peripheral region may be removed from at least a portion of the periphery to form a single liquid crystal display.

In the first pre-substrate forming process, step P11 of forming active elements is performed by a known method including film deposition, photoetching, and anodic oxidation to form the wirings 112 and 118 and the active elements 113. Then, in step P12 of forming pixel electrodes, a thin film of ITO (indium-tin oxide) is deposited by sputtering or the like and patterned to form the pixel electrodes 114.

Next, in step P13 of forming spacers, a photosensitive resin such as an acrylic resin containing a sensitizer or the like is applied, and then exposure and development are performed to form the spacers 17 and 17′. Then, in step P14 of forming an alignment film, the alignment film 17 is formed. In rubbing step P15, the alignment film 17 is rubbed, and in step P16 of arranging sealants, the sealant 13 is arranged to surround a region to be used as the display region G by a dispenser, screen printing, or the like so that an opening is formed in the sealant 13. The first pre-substrate 11 is formed by the above-described steps.

On the other hand, in the second pre-substrate forming process, first, step P21 of forming a color filter is performed to form the color filter 15 by photolithography. The colored layers 15R, 15G, and 15B are formed by using coloring materials each containing a transparent resin base such as an acrylic resin or the like and a dye or pigment dispersed therein. Preferably, the coloring material containing a sensitizer is applied, and then exposure and development are performed to form each of the colored layers. This step is performed for each of plural types of colored layers. In step P21 of forming a plurality of colored layers, the light shielding layers 15K are also formed at the same time as the colored layers. When the dummy pattern 18 is formed using the colored layers, the dummy pattern 18 is also formed in step P21 at the same time as the colored layers.

Next, in step P22 of forming counter electrodes, the counter electrodes 122 are formed. The counter electrodes 122 are formed by a method in which a thin film of ITO (indium-tin oxide) is deposited by sputtering, and then patterned by etching or the like. Next, in step P23 of forming an alignment film, the alignment film 123 is formed by applying a polyimide resin and burning the resin. Next, in rubbing step P24, the alignment film 123 is rubbed. The second pre-substrate 12 is formed by these steps.

Next, in substrate bonding step P31, the first and second pre-substrates 11 and 12 are bonded together with the sealant 13 provided therebetween. In sealant curing step P32, in the state where the first and second pre-substrates 11 and 12 are bonded together under pressure, the sealant 13 is cured by light irradiation or heating according to the curing characteristics of the sealant 13. As a result, the pre-panel structure 10 is formed.

Next, in panel dividing step P33, the substrates of the pre-panel structure 10 are divided by scribe braking, laser breaking, or the like according to demand so that the opening (liquid crystal injection hole) of the sealant 13 is open at the end surface. Usually, the pre-panel structure is divided into strips to form strip-shaped panel structures having a plurality of pre-panel regions with the openings of the sealants arrayed along the edge. In liquid crystal injection step P34, a liquid crystal is injected into the panel structure from the opening of the sealant 13. Then, in liquid crystal sealing step P35, a sealing agent is applied to the opening of the sealant 13 and then cured to seal the liquid crystal. The liquid crystal is sealed to form the liquid crystal layer 130.

Then, in panel dividing step P36, the panel structure is divided into respective panel structures according to demand. In mounting step P37, the driving circuits 141, 142, and 143 are mounted on the first substrate 110 of each of the panel structures obtained by dividing. In this step, a flexible substrate may be connected to the input terminals 144 of the electro-optic device 100 using an anisotropic conductive material. The electro-optic device 100 is completed through these steps.

Although, in this embodiment, the spacers are formed by photolithography, the method for forming the spacers of the invention is not limited to the above method. For example, the spacer arrangement of this embodiment can be realized even by disposing the spacers at respective predetermined positions on the substrate. More specifically, the spacers are formed by a method in which a spacer dispersion containing the spacers uniformly dispersed in a solvent is ejected on the substrate by an ink-jet system. In this method, droplets of the spacer dispersion can be accurately landed on the predetermined positions of the substrate, and the spacers can be disposed at the predetermined positions on the substrate by evaporating the solvent from the droplets. In this case, when recesses are formed at the predetermined positions of the substrate, the droplets can be landed in the recesses to improve the positional precision of the spacers. Also, when the surfaces of the spacers are coated with a thermoplastic resin, the spacers can be fixed to the substrate by heat-melting the thermoplastic resin of the spacers on the substrate.

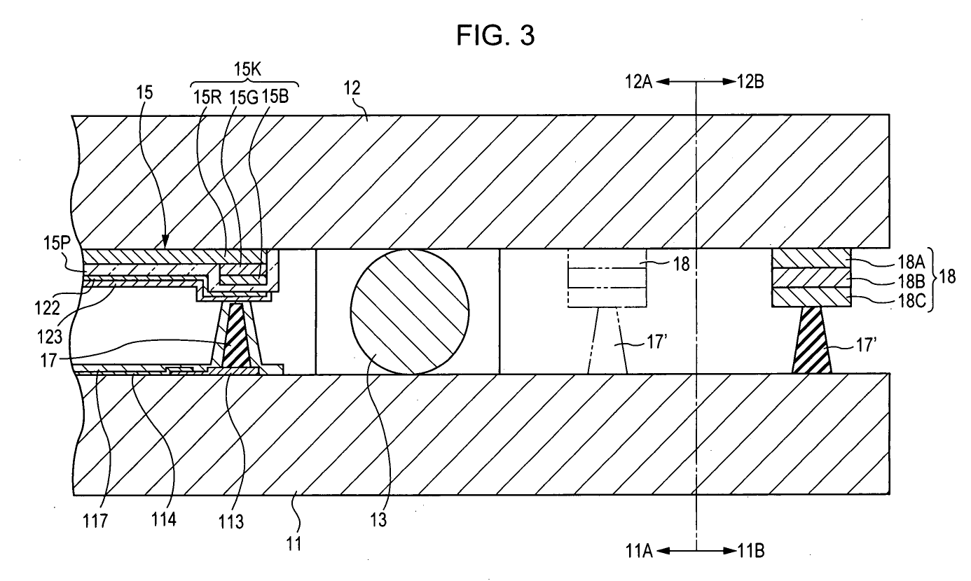

Next, the spacers 17′ and the dummy pattern 18 will be described in detail with reference to FIGS. 3, 4, and 5. In the pre-panel structure 10 of this embodiment, the inter-substrate gap is defined using the spacers 17 inside the sealant 13. On the other hand, the inter-substrate gap outside the sealant 13 is defined using the stacked structure formed by laminating the spacer 17′ and the dummy pattern 18. However, the gap defined by the spacers 17 inside the sealant 13 is generally smaller than the gap defined by the spacers 17′ and the dummy pattern 18 outside the sealant 13 because the alignment films 117 and 123, the color filter 15, the light shielding layers 15K, and the active elements 113 are deposited inside the sealant 13. In this embodiment, the spacers 17 are formed to the same height as that of the spacers 17′, and thus the difference between the gaps to be defined is compensated for by the dummy pattern 18.

In this embodiment, the dummy pattern 18 comprises the colored layers constituting the color filter 15. Specifically, the dummy pattern 18 comprises a stacked structure formed by laminating a dummy layer 18A comprising the same material as the colored layer 15R, a dummy layer 18B comprising the same material as the colored layer 15G, and a dummy layer 18C comprising the same material as the colored layer 15B, the colored layers 15R, 15G, and 15B constituting the color filter 15. Each of the dummy layers of the dummy pattern 18 is formed at the same time as the corresponding colored layer to form the dummy pattern 18 at the same time as the color filter 15.

In this embodiment, the dummy pattern 18 is wider than the light shielding layers 15K, and is formed to a thickness larger than that of the light shielding layers 15K. This is because when a plurality of layers is laminated to form the stacked structure, as the width of the stacked structure decreases, the thickness of the stacked structure tends to become smaller than the total thickness of the layers formed in an area sufficiently larger than the thickness of each layer. The light shielding layers 15K formed between the respective pixel regions P generally have a width of about 5 μm to 15 μm, while the dummy pattern 18 can be formed with a width of 10 times or more as wide as the width of the light shielding layers 15K. Therefore, the dummy pattern 18 can be formed to a thickness larger than that of the light shielding layers 15K. Also, since the dummy pattern 18 having the stacked structure with a large width has substantially the same thickness as the total thickness of the layers, the thickness can be more precisely determined. Since the dummy pattern 18 can be securely formed to a sufficient thickness, the inter-substrate gap outside the sealant 13 can be defined to the same as the inter-substrate gap inside the sealant 13 by laminating the spacer 17′ and the dummy pattern 18.

In this case, when the thickness of the dummy pattern 18 is required to be controlled for defining the same inter-substrate gap inside and outside the sealant 13, the thickness can be changed by changing the number of the layers of the dummy pattern 18. Also, a dummy layer comprising the same material as the protective film 15P covering the color filter 15 may be singly formed or may be laminated on the colored layers. In this case, the thickness of the dummy pattern 18 can be changed in a wider range. Of course, another layer may be laminated on the colored layer or the protective layer. In any case, each of the colored layers and the protective film has a thickness of about 1 μm to 2 μm, and thus is most suitable as a component for compensating the height of the spacers 17′ in the electro-optic device 100.

In the embodiment shown in FIG. 3, the stacked structure comprising the spacer 17′ and the dummy pattern 18 is disposed in the portion where the first peripheral region 11B faces the second peripheral region 12B. However, the stacked structure comprising the spacer 17′ and the dummy pattern 18 may be disposed in the portion where the first substrate region 11A faces the second substrate region 12A outside the sealant 13, as shown by two-dot chain lines in FIG. 3. However, in this case, the stacked structure remains at the outer periphery (outside the sealant 13) of the electro-optic device 100 after the first peripheral region 11B and the second peripheral region 12B are removed, as shown by II in FIG. 7.

In FIG. 7, the spacers 17 inside the sealant 13 and the spacers 17′ and the dummy pattern 18 shown by II are partially shown. However, in fact, the spacers 17 are uniformly dispersed inside the sealant, and the spacers 17′ and the dummy pattern 18 are also uniformly arranged outside the sealant. The spacing of the spacers 17 and 17′ shown in the drawing are not actual spacing for the sake of convenient drawing.

In this embodiment, as described above, the stacked structure comprising the spacer 17′ and the dummy pattern 18 is disposed between the substrates outside the sealant 13 to define the inter-substrate gap outside the sealant 13, and thus the inter-substrate gap outside the sealant 13 can be prevented from becoming smaller than that inside the sealant 13. Therefore, in bonding the substrates together, a decrease in the inter-substrate gap outside the sealant 13 can be prevented to prevent deformation of the substrates with the sealant 13 serving as a fulcrum, and consequently, an increase in the inter-substrate gap inside the sealant 13 can be prevented to prevent variations in the inter-substrate gap within the display region G.

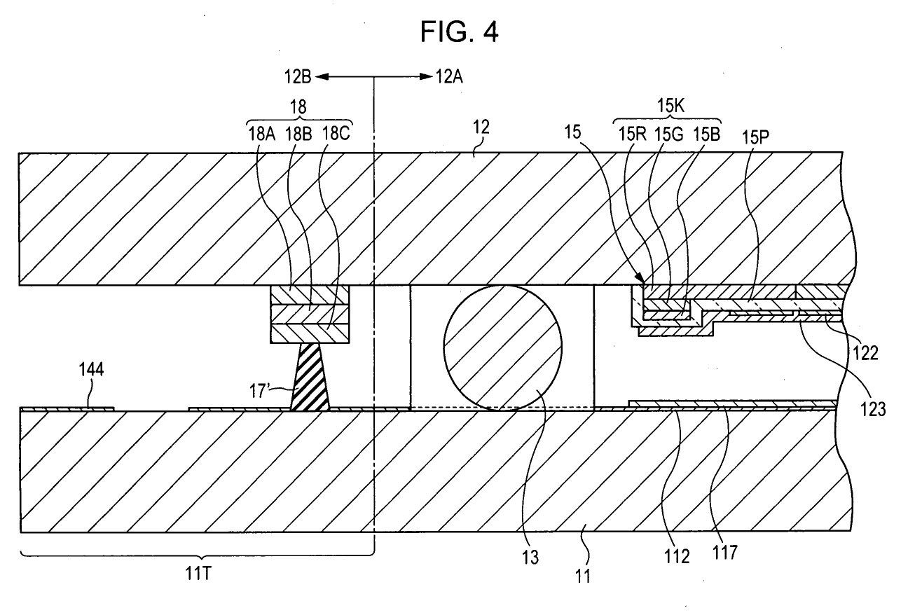

As shown in FIG. 7, in the electro-optic device 100, the first substrate 110 has the substrate projecting portion 110T projecting outward beyond the contour of the second substrate 210. The substrate projecting portion 110T corresponds to the projecting portion exposed without being covered with the second substrate 120. In order to form the substrate projecting portion 110T, the second peripheral region 12B opposed to the substrate projecting regions 11T to be used as the respective substrate projecting portions 110T as shown in FIG. 4 may be separated from the pre-panel structure 10 in the process for forming the electro-optic device 100.

In this embodiment, the stacked structure comprising the spacer 17′ and the dummy pattern 18 is disposed between the substrate projecting regions 11T and the opposing second peripheral region 12B, as shown in FIG. 4. The stacked structure is formed on the substrate protecting portion 110T to avoid the wirings 112 and 118, as shown by III in FIG. 7. The reason for this is to prevent the problem that the wirings 112 and 118 are affected by the spacers 17′ when the second peripheral region 12B opposing the substrate projecting regions 11T is removed. When the second peripheral region 12B is removed, the spacers 17′ are generally separated from the dummy pattern 18 formed on the second peripheral region 12B and remain on the substrate projecting portions 110T.

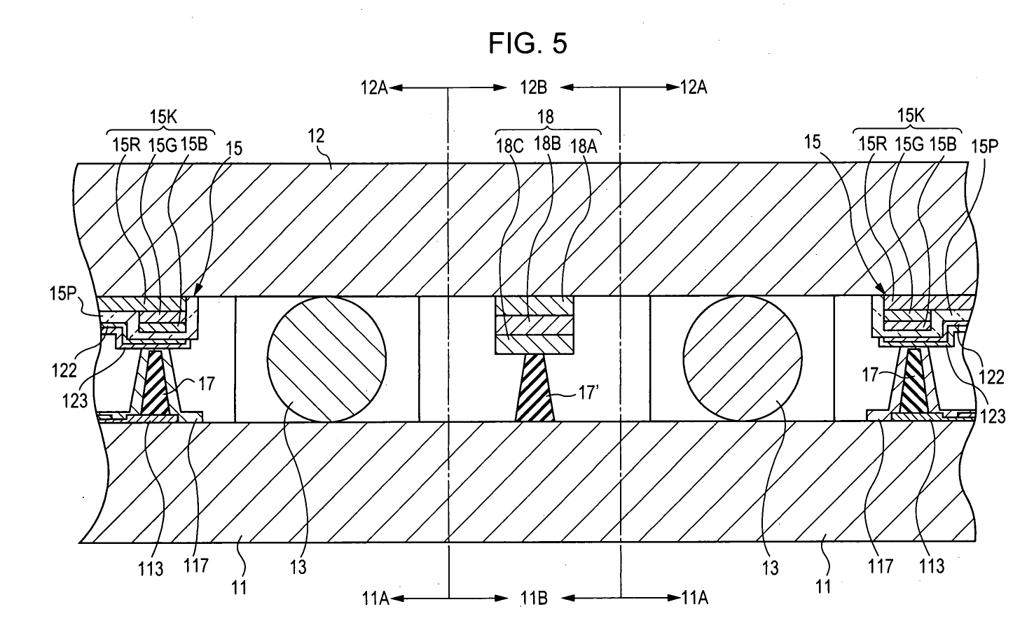

FIG. 5 shows the configuration of the pre-panel structure in which the first peripheral region 11B and the second peripheral region 12B are disposed between the respective pre-panel regions. In each of the peripheral regions between the respective pre-panel regions, basically, the stacked structure comprising the dummy pattern 18 and the spacer 17′ is provided.

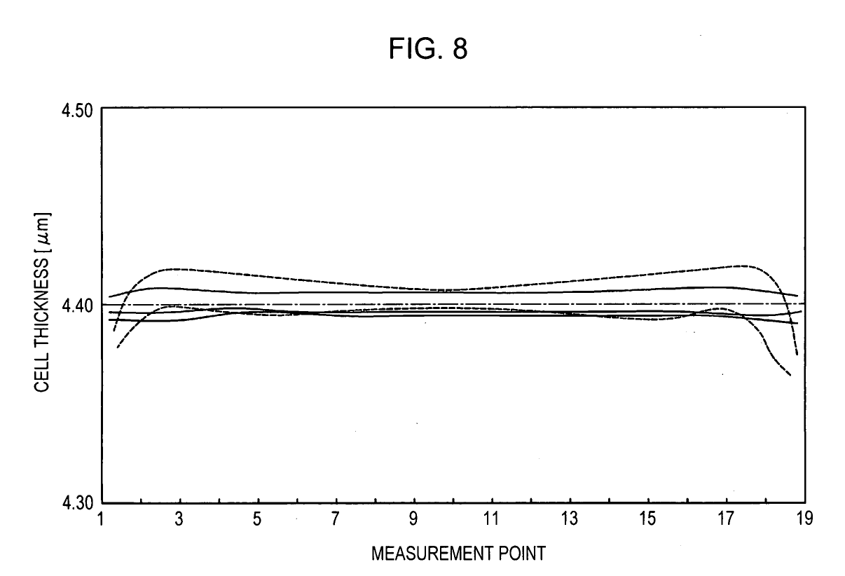

FIG. 8 is graph showing the results of measurement of the inter-substrate gap (cell thickness) at the 19 points X to Y shown in FIG. 7 with respect to the electro-optic device 100 manufactured by the method according to the embodiment of the invention. In this graph, three solid lines show the measurement data of three examples of the configuration of the embodiment, and two broken lines show the measurement data of two conventional examples in which spacers are formed only in a region inside the sealant 13.

The graph of FIG. 8 indicates that in the embodiment, the cell thickness in the display region G has high uniformity, and the cell thickness outside the display region G little changes. However, in the conventional examples, the cell thickness in the periphery of the display region G is larger than that in the central portion, and the cell thickness outside the display region G has a peak and rapidly decreases outside the peak. The graph shows that the inter-substrate gap inside the sealant increases with the sealant serving as a fulcrum because the inter-substrate gap outside the sealant decreases.

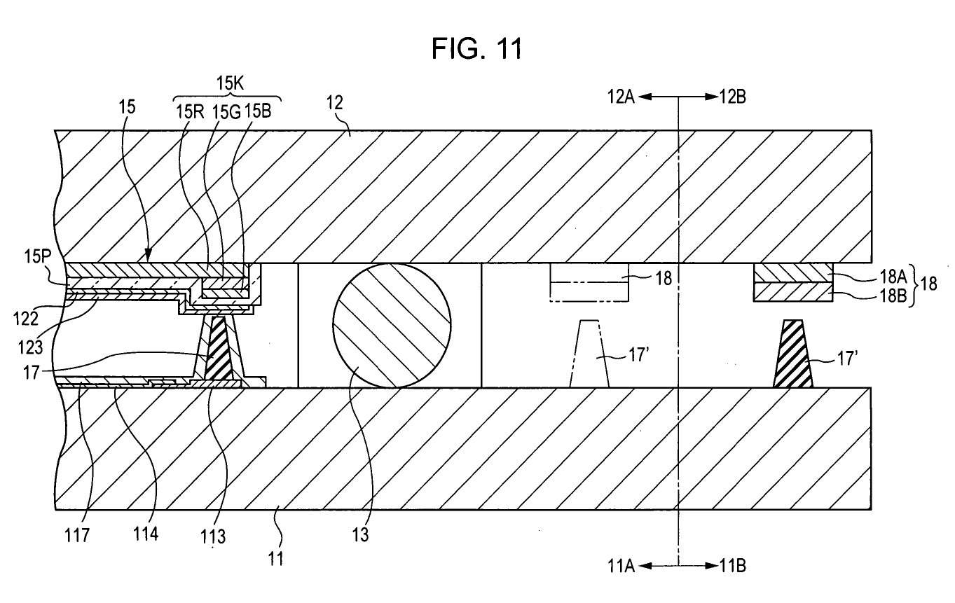

FIG. 11 is an enlarged partial sectional view showing a stacked structure comprising the dummy pattern 18 and the spacer 17′ according to another embodiment. In this embodiment, the thickness of the stacked structure disposed in the peripheral region, i.e., the total thickness of the dummy pattern 18 and the spacer 17′, is slightly smaller than the inter-substrate gap of the pre-panel structure. In the pre-panel structure, a space is formed between the dummy pattern 18 and the spacer 17′. Even when the thickness of the stacked structure is slightly smaller than the inter-substrate gap, the substrates can be supported by the dummy pattern 18 and the spacers 17′ in press-bonding the substrates together, and thus the same effect as described above can be achieved. In the embodiment shown in FIG. 11, the dummy pattern 18 is disposed on the substrate 12, and the spacer 17′ is disposed on the substrate 11, the space being formed between the dummy pattern and the spacer 17′. However, the structure is not limited to this, and the dummy pattern 18 and the spacer 17′ may be laminated on one of the substrates 11 and 12 to form the stacked structure on only one of the substrates with a space between the stacked structure and the other substrate.

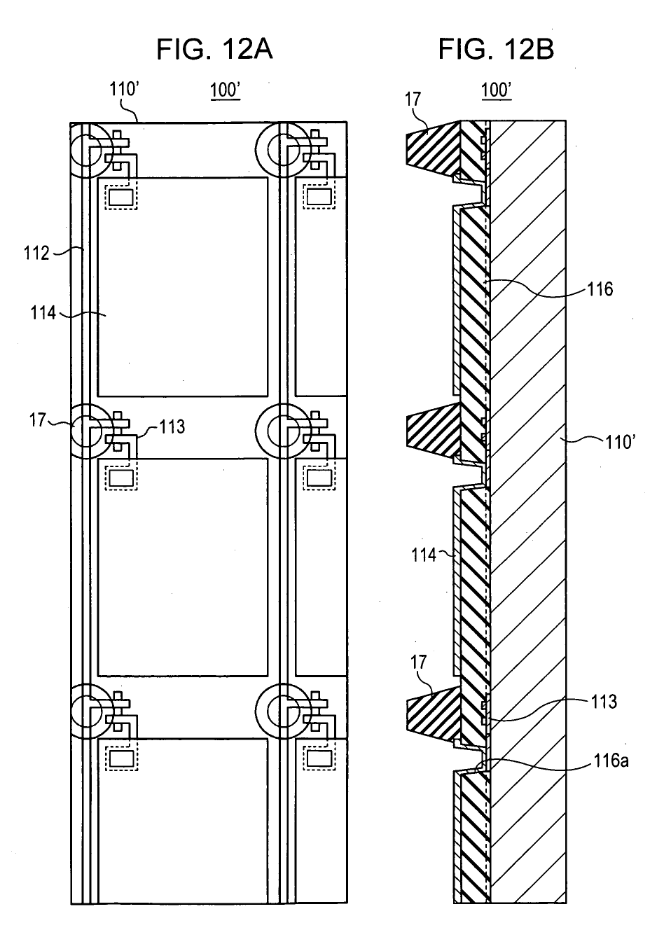

FIG. 12A is a partial plan view showing the structure of a first substrate 110′ as a component of an electro-optic device 100′ according to still another embodiment in which the above-described embodiment is partially modified, and FIG. 12B is a partial sectional view of the first substrate 110′. The portions not shown in the drawings are the same as in the above embodiment, and the same portions are denoted by the same reference numerals as in the above embodiment. Description thereof is omitted.

In this embodiment, an insulating film 116 comprising a transparent material such as an acrylic resin or the like is formed on the wirings 112 and the active elements 113 on the first substrate 110′, and the pixel electrodes 114 are formed on the insulating film 116. The pixel electrodes 114 are electrically connected to the respective active elements 113 through the contact holes 116a formed in the insulating film 116. The spacers 117 are also on the insulating film 116. The insulating film 116 is generally formed to a thickness of about 1 μm to 3 μm and preferably about 2 μm.

By forming the insulating film 116, the influence of the parasitic capacitance produced between the wirings 112 and the pixel electrodes 114 can be suppressed to improve display quality. Since the insulating film 116 comprises a transparent material, the electro-optic device 100′ can be used as a transmissive, reflective, or transflective display device.

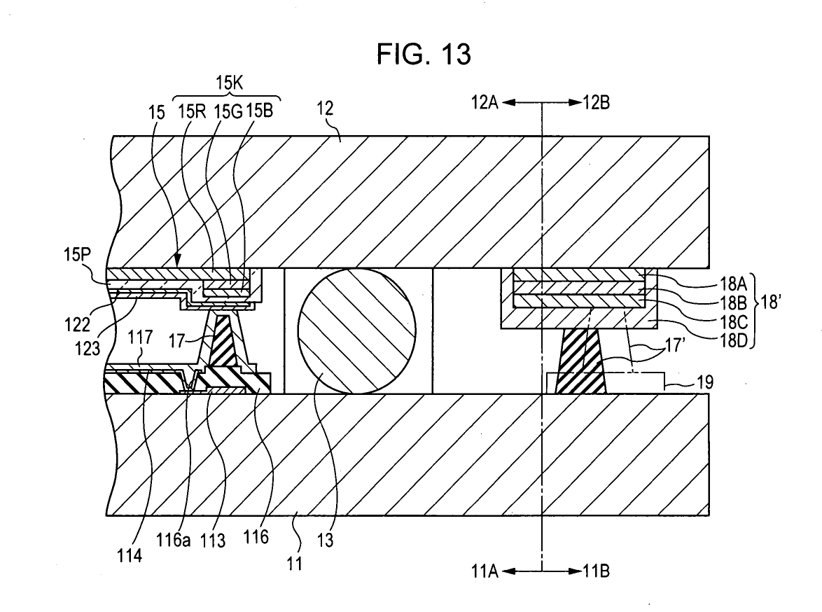

FIG. 13 is an enlarged sectional view showing a portion of the pre-panel structure used in the process for manufacturing the electro-optic device 100′. In the embodiment, the insulating film 116 is present, thereby significantly increasing the difference between the gap defined by the spacers 17 in the display region and the gap defined by the spacers 17′ and the dummy pattern 18 outside the sealant 13. Therefore, in the pre-panel structure of the embodiment shown in FIG. 13, a dummy pattern 18′ comprises a laminate of a plurality of colored layers 18A, 18B, and 18C which are formed using the same material at the same time as the plurality of colored layers constituting the color filter 15, and a dummy layer 18D formed using the same material at the same time as the protective film 15P covering the color filter 15. In this case, the thickness of the dummy pattern 18′ can be made larger than that in the above embodiment, and the inter-substrate gap increased by the insulating film 116 can be defined by the spacer 17′ and the dummy pattern 18′ outside the sealant 13.

In this embodiment, a dummy pattern 19 is formed on the first pre-substrate 11 using the same material at the same time as the insulating film 116, and the spacers 17′ are formed on the dummy pattern 19, thereby decreasing the required thickness of the dummy pattern 18′, as shown by two-dot chain lines in FIG. 13. In the embodiment shown in FIG. 13, the dummy pattern 18D corresponding to the protective film 15P need not be formed in the dummy pattern 18′. Even when the inter-substrate gap becomes large outside the sealant and in the peripheral region, the substrates can be securely supported by forming the stacked structure comprising a laminate of the colored layers or the protective film to be laminated on the spacer 17′ and another layer, as described above.

In the above-described embodiments, the inter-substrate gap is defined by the stacked structure comprising the spacer 17′ and the dummy pattern 18 outside the sealant, particularly in the peripheral region which is finally removed in the manufacturing process. Therefore, a decrease in the inter-substrate gap in the peripheral region of the pre-panel structure 10 can be suppressed in bonding of the substrates together, thereby preventing variations in the inter-substrate gap within the display region G.

In particular, the dummy pattern 18 laminated on the spacer 17′ comprises at least one of the plurality of colored layers 15R, 15G, and 15B constituting the color filter 15 or the protective film 15P covering the color filter 15, or a laminate of these layers. Therefore, the dummy pattern 18 having a sufficient thickness can be formed without a change in the manufacturing process. As a result, the inter-substrate gap in the periphery of the panel can be easily securely defined to the same as the inter-substrate gap in the display region G.

Electronic Apparatus

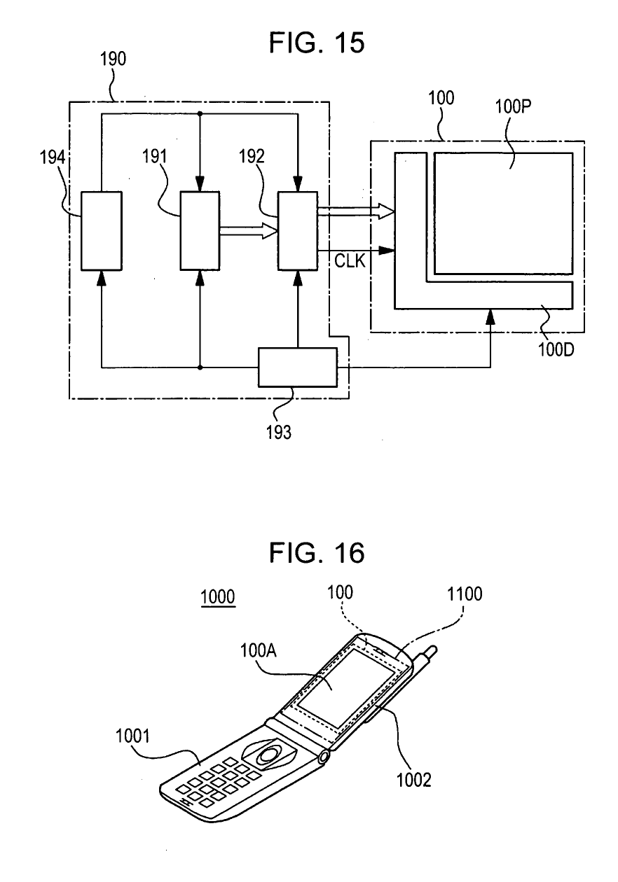

Finally, the configuration of an electronic apparatus using the electro-optic device 100 according to the above embodiment will be described with reference to FIGS. 15 and 16.

FIG. 15 is a schematic block diagram showing the configuration of a display system according to an embodiment of the invention. The electronic apparatus shown in FIG. 15 comprises the electro-optic device 100 described above, and a control unit 190 for controlling the electro-optic device 100. The electro-optic device 100 comprises a panel structure 100P formed as described above, and a driving unit 100D for electrically driving the panel structure 100P. The driving unit 100D comprises the driving circuits 141, 142, and 143 mounted on the substrate projecting portion 110T. However, the driving unit 100D may be formed on a wiring board such as a flexible board or the like mounted on the substrate projecting portion 110T, or may be formed apart from the electro-optic device 100. The driving unit 100D includes a scanning line driving circuit, a data line driving circuit, and an inspection circuit.

The control unit 190 is adapted for supplying control signals and electric power to the driving unit 100D, and includes a display information output source 191, a display processing circuit 192, a power supply circuit 193, and a timing generator 194.

The display information output source 191 includes a memory comprising ROM (Read Only Memory), RAM (Random Access Memory), or the like, a storage unit comprising a magnetic recording disk, an optical recording disk, or the like, and a tuning circuit for tuning and outputting digital image signals. On the basis of the various clock signals generated by the timing generator 194, display information is supplied in the form of predetermined format image signals to the display information processing circuit 192.

The display information processing circuit 192 comprises various known circuits such as a serial-parallel converter, an amplification-repetition circuit, a rotation circuit, a gamma correction circuit, a clamp circuit, and the like. Processing of the input display information is executed, and the image information is supplied to the driving unit 100D together with the clock signal CLK. The power supply circuit 193 supplies a predetermined voltage to each of the above-described components.

FIG. 16 shows a cellular phone 1000 as an electronic apparatus according to an embodiment of the invention. The cellular phone 1000 includes a circuit board 1100 disposed in a case body, and the electro-optic device 100 mounted on the circuit board 1100. Also, operation buttons are arrayed on the front of an operating unit 1001 of the case body, and an antenna is extendably amounted at an end of a display unit 1002 in which the screen 100A of the electro-optic device 100 is disposed. Furthermore, a microphone is built in an and of the operating unit 1001, and a speaker is built in an end of the display unit 1002.

The electro-optic device according to the invention is not limited to the device shown in the drawing, and, of course, various changes can be made within the scope of the gist of the invention. Although, in the above-described embodiments, the columnar spacers are provided and fixed on one of the pair of pre-substrates in the manufacturing process, the spacers contained in the stacked structure may be particulate spacers separated from the substrates. Also, the stacked structure of the colored layer or the protective layer and the columnar spacer may be formed by disposing the colored layer or the protective layer and the spacer on one of the substrates.

Although, in the above embodiments, TFD elements are used as the active elements, other active elements such as TFT (Thin Film Transistor) can be used in place of the TFD elements. Furthermore, in the embodiments, an active matrix device is formed, but a passive matrix display may be formed.

Although, in the above embodiments, the configuration of a liquid crystal display is described, the invention can be similarly applied to various electro-optic devices such as an electroluminescence device, an organic electroluminescence device, a plasma display, an electrophoretic display, devices using electron emission elements (Field Emission Display, Surface-Conduction Electron Emitter Display, and the like), and the like.

1. A method for manufacturing an electro-optic device having a panel structure including an electro-optic material disposed between a pair of substrates, a spacer disposed between the pair of substrates to define a gap therebetween, and a colored layer provided between one of the pair of substrates and the electro-optic material, the method comprising:
forming a pair of pre-substrates;
bonding the pair of pre-substrates together to form a pre-panel structure, the pre-panel structure including a substrate region and a peripheral region, the peripheral region including a stacked structure including the spacer overlapping the colored layer; and
dividing the substrate region of the pre-panel structure from the peripheral region to form the panel structure corresponding to the substrate region.

2. A method according to claim 1, the substrate region including another stacked structure including the spacer overlapping the colored layer.

3. The method according to claim 1, wherein the stacked structure includes a laminate of the colored layer and at least one of a colored layer.

4. The method according to claim 1, wherein the stacked structure includes a laminate of the colored layer and a protective film overlapping the colored layer.

5. The method according to claim 1, wherein the panel structure further comprises an electrode for applying an electric field to the electro-optic material,a projecting portion disposed on one of the pair of substrates to project beyond the other substrate, and wiring and terminal provided on the projecting portion and conductively connected to the electrode, the stacked structure being disposed in a region corresponding to the projecting portion in which the wiring and the terminal are not formed.

6. The method according to claim 1, wherein the electrode and the wiring are laminated with an interlayer insulating film provided therebetween, and the stacked structure includes the interlayer insulating film.

7. An electro-optic device comprising:
a pair of substrates bonded together with a sealant provided therebetween;
a colored layer and an electro-optic material which are disposed between the pair of substrates;
a spacer disposed between the pair of substrates, for defining a gap therebetween; and
a stacked structure disposed between the pair of substrates and outside the sealant, the stacked structure including the spacer overlapping the colored layer.

8. An electro-optic device comprising:
a pair of substrates bonded together with a sealant provided therebetween;
a colored layer, an electro-optic material, and an electrode for applying an electric field to the electro-optic material, which are disposed between the pair of substrates;
a projecting portion provided on one of the pair of substrate to project beyond the other substrate;
a spacer disposed between the pair of substrates and on the projecting portion; and
a wiring and a terminal which are provided on the projecting portion and conductively connected to the electrode.
